(19) United States
(12) Patent Application Publication
(10) Pub. No.: US 2016/0238057 A1
(43) Pub. Date: Aug. 18, 2016

(54) DEVICE FOR CLAMPING ARTICLES

(71) Applicant: SCHULTE-ELEKTROTECKNIK GMBH & CO. KG, Lüdenscheid (DE)

(72) Inventors: Hendrik RITTINGHAUS, Schalksmuehle (DE); Siegfried SCHULTE, Luedenscheid (DE); Juergen MENGES, Halver (DE)

(73) Assignee: Schulte-Elektrotechnik GmbH & Co. KG, Luedenscheid (DE)

(21) Appl. No.: 15/029,083

(22) PCT Filed: Oct. 14, 2014
(86) PCT No.: PCT/EP2014/072053

§ 371 Date: Apr. 13, 2016

(30) Foreign Application Priority Data
Oct. 14, 2013 (DE) 20 2013 104 632.9
Jan. 24, 2014 (DE) 20 2014 100 298.7

(51) Int. Cl. F16B 37/08; H01R 13/621

(52) U.S. Cl. CPC F16B 37/0828; H01R 13/621; F16B 37/085

(57) ABSTRACT

A device for clamping articles on machine tops includes a support provided with a flange at one end and an annular outer surface provided with an external screw thread with at least one turn, onto which a threaded ring can be screwed, the threaded ring having an internal screw thread with at least one turn, wherein the turns of the internal screw thread and the turns of the external screw thread have discontinuities, the width of which is greater than the width of the turns.

The invention relates to an apparatus for clamping of objects to equipment plates, comprising a support that is provided with a flange at its one end, and has a ring mantle provided with an outside thread having at least one thread turn, onto which a threaded ring can be screwed, which ring has an inside thread having at least one thread turn.

Apparatuses of the type state initially are known. Thus, an electrical connection column as an insertion part is known from EP1 256 288 A1 for example, which column can be attached to an equipment plate by means of an apparatus of the type stated initially. The equipment plate can be a table plate; however, a wall plate or, for example, a base plate of a cabinet or the like can also be used for attachment.

With the known apparatuses, simple and, at the same time, reliable attachment of the respective objects to the equipment plates is possible. However, the apparatuses have the disadvantage that for clamping or loosening the apparatuses, the threaded ring must be screwed over the entire ring mantle. This is rather complicated, depending on the length of the ring mantle.

This is where the invention wishes to provide a remedy. The invention is based on the task of allowing more convenient and, at the same time, faster operation of the apparatus. According to the invention, this task is accomplished in that the thread turns of the inside thread and the thread turns of the outside thread have interruptions, the width of which is greater than the width of the thread turns.

With the invention, an apparatus for clamping of objects to equipment plates is created, which can be operated more conveniently and more rapidly. This is brought about by means of the interruptions of the thread turns. Because of the interruptions, the possibility exists of turning the threaded ring into a position in which the thread turns of the ring are situated in the region of the interruptions in the thread turns of the support. In this position, the interruptions in the thread of the threaded ring are situated in the region of the thread turns of the support. Because the width of the interruptions is greater than the width of the thread turns, in this position the thread combination between outside thread of the support and inside thread of the ring is not in engagement. Consequently, the possibility exists of displacing the threaded ring on the support along its longitudinal axis, without any screwing movement. This is of significant advantage both when loosening and when tightening the apparatus. Thus, during tightening, the possibility exists of setting the threaded ring onto the free end of the ring mantle and bringing it up to the equipment plate with a simple movement, in the position described. Only in the immediate vicinity of the equipment plate does turning of the threaded ring take place, so that the thread turns of the support and of the threaded ring come into engagement. As a result, the screwing movement that leads to clamping of the apparatus can enter into engagement. Equally, simple loosening of the apparatus is possible, in that the method of procedure described above is carried out in the reverse sequence. Therefore it is no longer necessary to move the threaded ring along the entire outside thread of the support for tightening or loosening.

In a further development of the invention, the threaded ring is divided in at least one location. As a result, the possibility exists of spreading the threaded ring apart and moving it over the ring mantle of the support. This offers an additional increase in convenience, particularly in those cases in which objects that have electrical connection cables are clamped into the apparatus. To the extent that the electrical connection cables are passed out of the apparatus through the interior of the ring mantle, it is necessary, when tightening and loosening the apparatus, to guide the threaded ring along the electrical connection cables all the way to their free end, in order to be able to loosen the ring completely. As the result of the division of the ring, the possibility exists of spreading the ring apart and either setting it onto the ring mantle directly or opening the ring so far that moving past the electrical connection cables is made possible, in any case.

It is advantageous if the threaded ring is provided with a hinge. Using the hinge, operation of the ring is additionally facilitated. At the same time, the risk of destruction of the ring in the event of it unintentionally being opened too far is counteracted.

In an embodiment of the invention, the hinge is configured in the manner of a film hinge. This method of configuration of the hinge is simple in terms of production technology, and can be implemented inexpensively.

Preferably, at least one closure is provided on the threaded ring. The provision of a closure ensures reliability operability of the apparatus in the case of a divided configuration of the ring.

It is advantageous if the closure is configured in the manner of a snap closure. In this way, simple operation is guaranteed both when loosening and when closing the closure, and this is particularly advantageous in the installation situations of the apparatuses, some of which are difficult.

Other further developments and embodiments of the invention are indicated in the remaining dependent claims. Exemplary embodiments of the invention are shown in the drawings and will be described in detail below. The figures show:

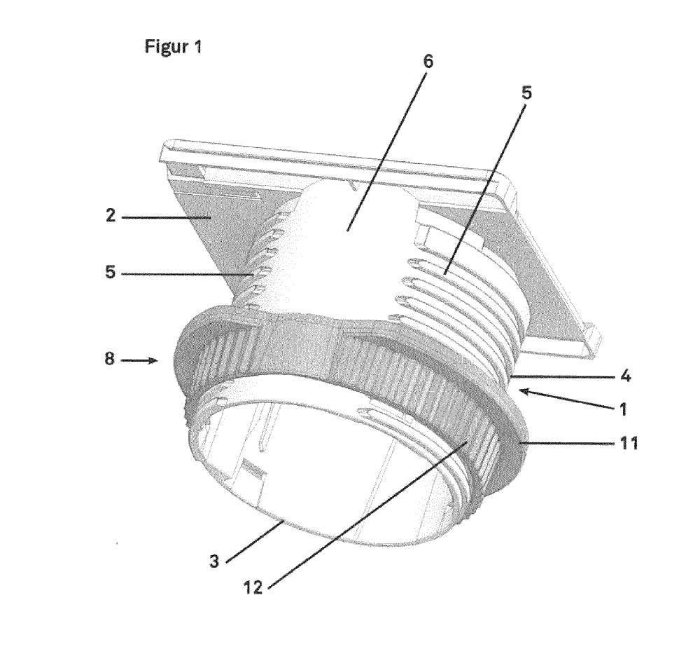

FIG. 1 the three-dimensional representation of an apparatus for clamping of objects to equipment plates;

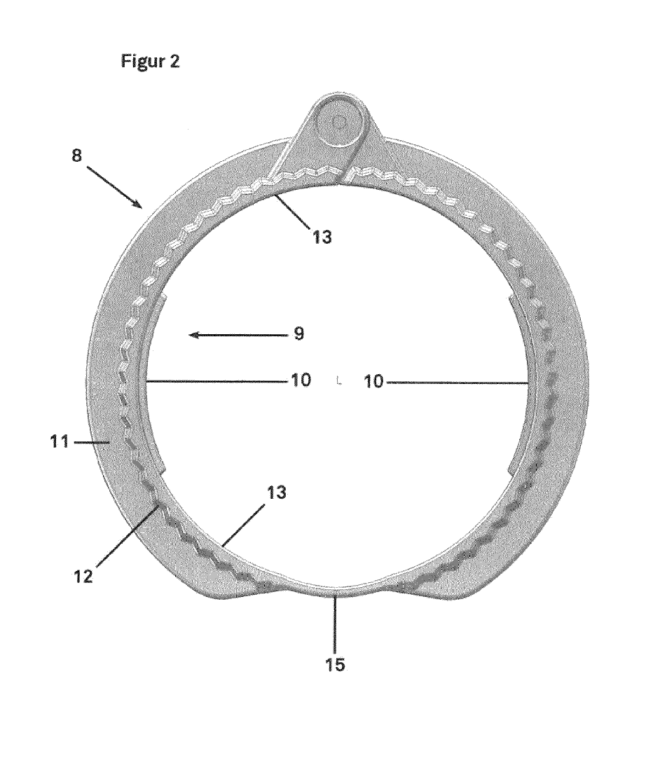

FIG. 2 the top view of a threaded ring;

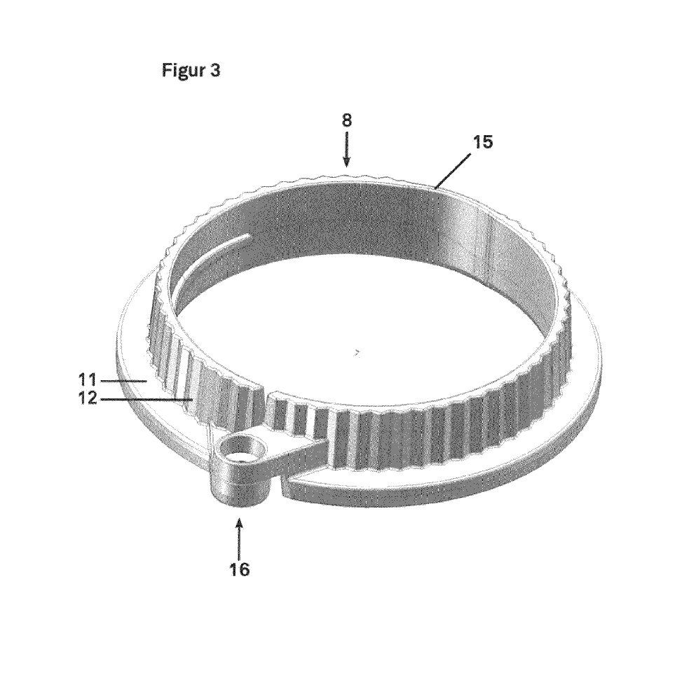

FIG. 3 the perspective representation of the threaded ring shown in FIG. 2;

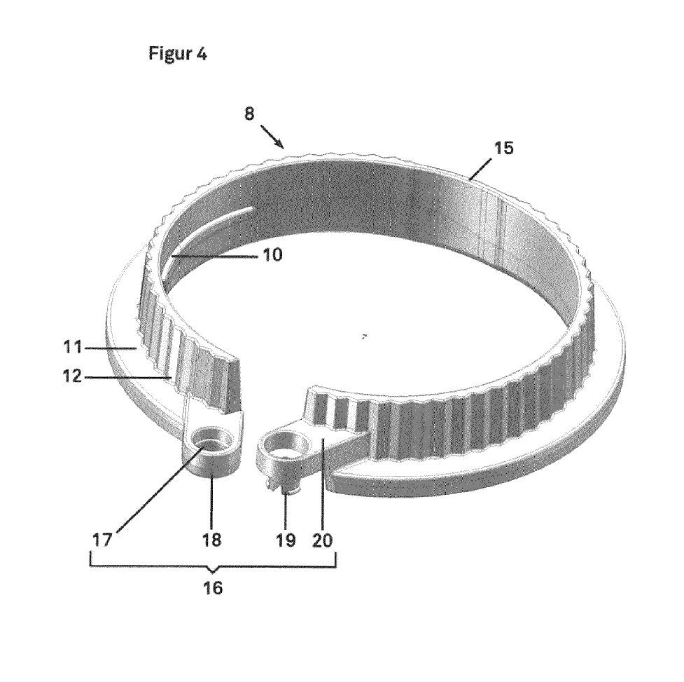

FIG. 4 the perspective representation of the threaded ring shown in FIG. 2, in the open position;

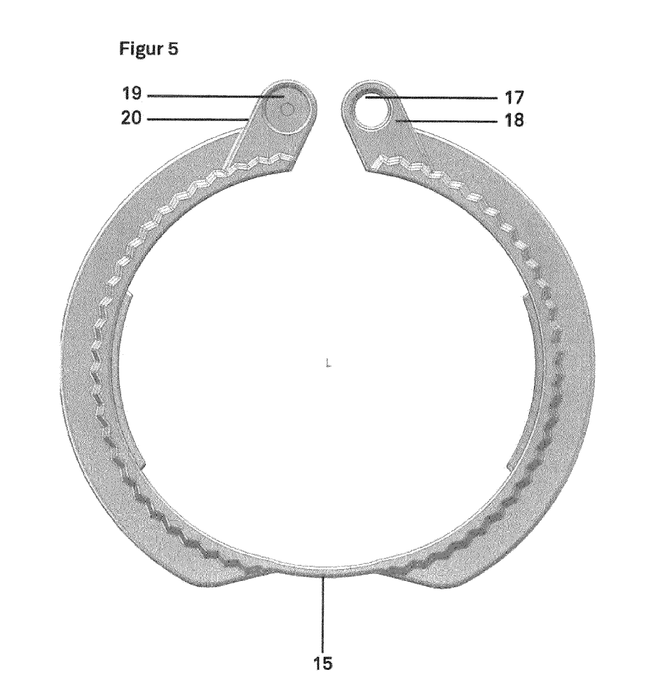

FIG. 5 the top view of the threaded ring shown in FIG. 4;

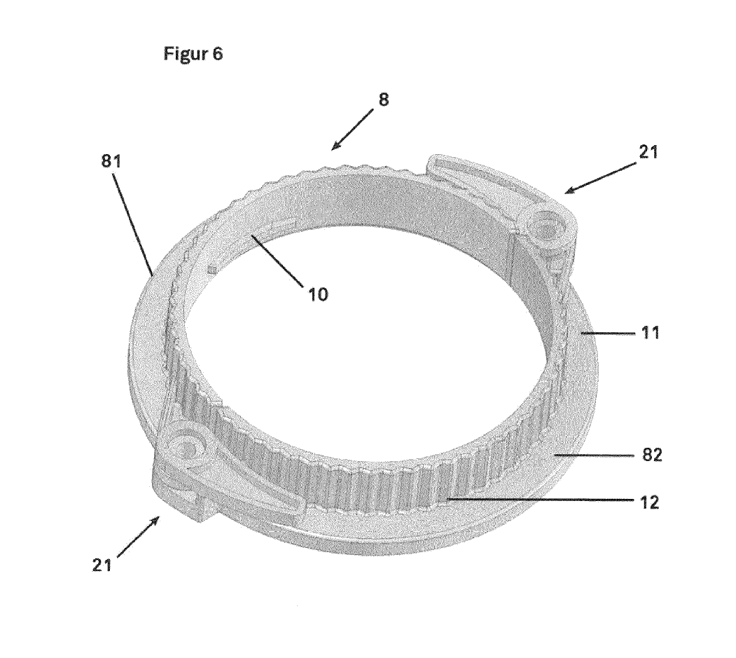

FIG. 6 the perspective representation of a threaded ring in a different configuration;

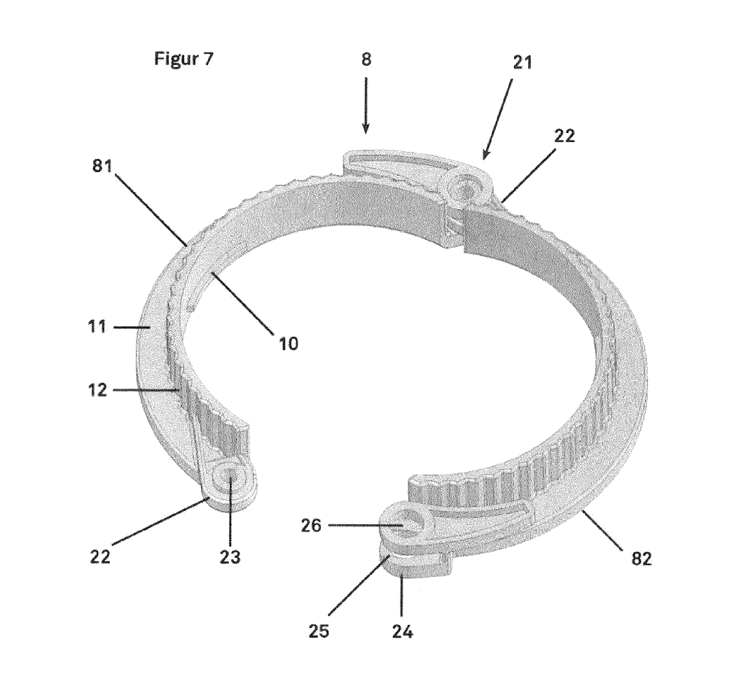

FIG. 7 the perspective representation of the threaded ring shown in FIG. 6, in the open position.

The apparatus for clamping of objects to equipment plates chosen as an exemplary embodiment comprises a support 1, which is provided with a flange 2 at its one end. The flange 2 lies on the equipment plate in the installed state of the apparatus. In the exemplary embodiment, the flange 2 has an essentially square configuration and serves for accommodation of further components, for example outlets or insertion locations for electrical devices. Furthermore, a cover in the form of a lid can be affixed to the flange 2 according to FIG. 1. In a modification of the exemplary embodiment, the possibility exists of configuring the flange 2 as a simple projecting edge that projects radially beyond the support 1.

The support 1 has a ring mantle 3 that is provided with an outside thread 4. The outside thread 4 comprises at least one thread turn 5. The thread turns 5 of the outside thread 4 have interruptions 6.

A threaded ring 8 can be screwed onto the outside thread 4 of the ring mantle 3; this ring has an inside thread 9 having at least one thread turn 10. The inside thread 9 corresponds to the outside thread 4 on the ring mantle 3 in the installed state. Because of the thread combination, the threaded ring 8 can be axially screwed onto the ring mantle 3. The threaded ring 8 has a stop 11 on its side facing the flange 2, with which stop the apparatus can be clamped in place on the equipment plate. On the outside, the threaded ring 8 is equipped with a riffling 12, which allows improved handling of the threaded ring 8 when screwing it onto and unscrewing it from the ring mantle 3.

The inside thread 9 has interruptions 13. The width of the interruptions 6 of the outside thread 4 as well as the width of the interruptions 13 of the inside thread 9 is greater than the width of the thread turns 5 of the outside thread 4 and of the thread turns 10 of the inside thread 9. This configuration allows displacement of the threaded ring 8 on the ring mantle 3 in an axial direction, without any screwing movement. This is made possible in that the thread turns 10 are shorter than the width of the interruption 6 on the ring mantle 3. At the same time, the thread turns 5 on the ring mantle 3 are shorter than the interruptions 13 of the threaded ring 8. Therefore the thread turns 5 and 10 are released in this position, thereby making displacement along the longitudinal axis of the ring mantle 3 possible. When tightening the apparatus, this position is cancelled by turning the threaded ring 8 on the ring mantle 3, so that the thread turns 10 enter into the thread turns 5, thereby causing the screwing movement and thereby tightening of the apparatus to take place. Loosening of the apparatus takes place in the reverse sequence. By means of displacement of the threaded ring 8 on the ring mantle 3 without a screwing movement, clear acceleration of the tightening or loosening of the apparatus is brought about, thereby significantly increasing the operating convenience.

The threaded ring 8 is configured in divided manner. In the exemplary embodiment according to FIGS. 1 to 5, the threaded ring 8 is divided at one location. The threaded ring 8 is provided with a hinge 15. In the exemplary embodiment according to FIGS. 1 to 5, the hinge 15 is configured in the manner of a film hinge. As can be seen in FIGS. 4 and 5, opening of the threaded ring 8 is thereby made possible without problems. A closure 16 is provided on the threaded ring 8. The closure 16 is disposed on the threaded ring 8 on the side that lies opposite the hinge 15. In the exemplary embodiment, the closure 16 is configured in the manner of a snap closure. For this purpose, the closure 16 has an extension 18 having a hole 17, which extension corresponds to an engagement element 19 provided on an extension 20. To close the closure, the free ends of the extensions 18 and 20 are positioned one on top of the other, and the engagement element 19 is pressed into the hole 17, so that these engage into one another. The threaded ring 8 is thereby closed, and can be moved on the ring mantle 3, axially along the ring mantle 3, both with and without a screwing movement.

In the exemplary embodiment according to FIGS. 6 and 7, the threaded ring 8 is divided at two locations. It is evident that two identically configured ring parts 81 and 82 are brought about in this way. In this case, the ring is provided with two closures 21, which are also snap closures. For this purpose, an extension 22 is provided on both ring halves 81 and 82, which extension is provided with a ring-shaped elevation 23. The extension 22 having the elevation 23 corresponds to an accommodation 24, in which a gap 25 is formed. The accommodation 24 is provided with a hole 26, the diameter of which corresponds to the outside diameter of the ring-shaped elevation 23. As can be seen in FIG. 6, the elevation 23 on the extension 22 engages into the hold 26 in the closed state, thereby closing the threaded ring 8. If only one closure 21 is open, the second closure 21 functions as a hinge, as can be seen in FIG. 7. The possibility also exists of also opening the second closure, so that the two ring halves 81 and 82 are completely separated from one another. Comparable to the representation in FIG. 4, simple opening of the threaded ring 8 is also possible in the exemplary embodiment according to FIGS. 6 and 7, in order to allow the ring mantle 3 to pass through. As soon as the ring mantle 3 is situated within the threaded ring 8, the two ring halves 81 and 82 are pivoted toward one another about the closure 21, which functions as a hinge, so that the extension 22 with elevation 23 moves into the accommodation 24 and locks in place there. The threaded ring 8 can then be moved on the ring mantle 3 in the axial direction. This can take place either by means of screwing it or by means of a movement without rotation, in that the thread turns 10 are positioned in the region of the interruptions 6 of the outside thread 4. Displacement and tightening then take place in the manner described with regard to the exemplary embodiment according to FIGS. 1 to 5.

1. Apparatus for clamping of objects to equipment plates, comprising a support (1) that is provided with a flange (2) at its one end, and has a ring mantle (3) provided with an outside thread (4) having at least one thread turn (5), onto which a threaded ring (8) can be screwed, which ring has an inside thread (9) having at least one thread turn (10), wherein the thread turns (10) of the inside thread (9) and the thread turns (5) of the outside thread (4) have interruptions (6, 13), the width of which is greater than the width of the thread turns (5, 10).

2. Apparatus according to claim 1, wherein the threaded ring (8) is divided on at least one side.

3. Apparatus according to claim 1, wherein the threaded ring (8) is provided with a hinge (15).

4. Apparatus according to claim 1, wherein the hinge (15) is configured in the manner of a film hinge.

5. Apparatus according to claim 1, wherein at least one closure (16, 21) is provided on the threaded ring (8).

6. Apparatus according to claim 1, wherein the closure (16, 21) is configured in the manner of a snap closure.
